(19) United States
(12) Patent Application Publication
(10) Pub. No.: US 2026/0237028 A1
(43) Pub. Date: Aug. 13, 2026

(54) HYBRID MODELS FOR SPECTRAL COMPUTED TOMOGRAPHY MATERIAL DECOMPOSITION

(71) Applicant: GE Precision Healthcare LLC, Waukesha, WI (US)

(72) Inventors: Pengwei Wu, Clifton Park, NY (US); Jed Douglas Pack, Glenville, NY (US); Sathish Ramani, Niskayuna, NY (US); Mingye Wu, Clifton Park, NY (US); Bruno Kristiaan Bernard De Man, Clifton Park, NY (US)

(21) Appl. No.: 19/052,964

(22) Filed: Feb. 13, 2025

(51) Int. Cl. G06T 5/70; G06T 7/00

(52) U.S. Cl. CPC G06T 5/70; G06T 7/0012; G06T 2207/10081

(57) ABSTRACT

A computer-implemented method for performing material decomposition includes acquiring, via a processing system including one or more processors, spectral computed tomography (CT) scan data. The computer-implemented method also includes utilizing, via the processing system, a hybrid model in conjunction with an optimization-based technique or a non-iterative inverse mapping to generate spectral CT basis material maps from the spectral CT scan data, wherein the hybrid model includes both calibration-data terms and physics-based terms.

### BACKGROUND

The subject matter disclosed herein relates to imaging systems and, more particularly, to a hybrid models for spectral computed tomography material decomposition.

Non-invasive imaging technologies allow images of the internal structures or features of a subject (patient, manufactured good, baggage, package, or passenger) to be obtained non-invasively. In particular, such non-invasive imaging technologies rely on various physical principles, such as the differential transmission of X-rays through the target volume or the reflection of acoustic waves, to acquire data and to construct images or otherwise represent the internal features of the subject.

For example, in X-ray-based imaging technologies, X-ray radiation spans a subject of interest, such as a human patient, and a portion of the radiation impacts a detector where the intensity data is collected. In digital X-ray systems, a detector produces signals representative of the amount or intensity of radiation impacting discrete pixel regions of a detector surface. The signals may then be processed to generate an image that may be displayed for review.

In one such X-ray based technique, known as computed tomography (CT), a scanner may project fan-shaped or cone-shaped X-ray beams from an X-ray source at numerous view angle positions about an object being imaged, such as a patient. The X-ray beams are attenuated as they traverse the object and are detected by a set of detector elements which produce signals representing the intensity of the incident X-ray intensity on the detector. The signals are processed to produce data representing the line integrals of the linear attenuation coefficients of the object along the X-ray paths. These signals or processed signals are typically called “projection data” or just “projections”. By using reconstruction techniques, such as filtered backprojection, images may be generated that represent a volume or a volumetric rendering of a region of interest of the patient or imaged object. In a medical context, pathologies or other structures of interest may then be located or identified from the reconstructed images or rendered volume.

Some CT detectors include photon counting detectors. A photon counting detector directly converts each detected X-ray photon into an electrical signal. An X-ray photon is absorbed in a semiconductor material (e.g., cadmium zinc telluride (CZT), cadmium telluride (CdTe), silicon, perovskites, etc.) resulting in generation of an electrical charge proportional to the X-ray photon energy. The charge is fed into application-specific integrated circuit (ASIC), which tracks individual current pulses, determines the energy of the X-ray photons that generated these pulses and assigns them to the appropriate energy bins. Specifically, one or more counters-corresponding to one or more energy ranges (so-called “energy bins”)—are incremented depending on whether the energy (keV) of the X-ray photon falls within that range.

Photon-counting CT (PCCT) is an emerging tomographic imaging technique that offers improved diagnostic performance through better spatial and energy resolution. It uses multiple energy bins to measure spectral dependence of the X-ray attenuation, similar to dual energy CT imaging or any other forms of spectral CT. However, high-quality material decomposition is still a challenging issue due to various sources of image noise and artifacts (e.g., quantum noise), charge sharing, pulse pileup, and beam hardening effects). Material decomposition (i.e., generating material path length estimates from multiple energy bin measurements) is essentially an inverse problem, whose solution requires an accurate definition of a model. Previous models have been generated through either careful calibration or imaging physics alone. In another embodiment, material decomposition can be accomplished via non-iterative evaluation of an inverse mapping that converts measured data to material pathlengths. Prior arts have focused either on physics-based and simulation-based definitions of such inverse mappings or on constructing such inverse mappings using measured calibration data. In both forward model-based and inverse mapping-based material decomposition, imaging physics-based and calibration-based approaches have their inherent pros and cons, resulting in non-ideal material maps. Therefore, there is an unresolved need for a new model for material decomposition that combines the benefits of both imaging-physics-based and calibration-based approaches.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a computer-implemented method for performing material decomposition is provided. The computer-implemented method includes acquiring, via a processing system including one or more processors, spectral computed tomography (CT) scan data. The computer-implemented method also includes utilizing, via the processing system, a hybrid model in conjunction with an optimization-based technique or a non-iterative inverse mapping to generate spectral CT basis material maps from the spectral CT scan data, wherein the hybrid model includes both calibration-data terms and physics-based terms.

In another embodiment, a system performing material decomposition is provided. The system includes a memory encoding processor-executable routines. The system also includes a processing system including one or more processors and configured to access the memory and to execute the processor-executable routines, wherein the processor-executable routines, when executed by the processing system, cause the processing system to perform actions. The actions include acquiring spectral computed tomography (CT) scan data. The actions also include utilizing a hybrid model in conjunction with an optimization-based technique or a non-iterative inverse mapping to generate spectral CT basis material maps from the spectral CT scan data, wherein the hybrid model includes both calibration-data terms and physics-based terms.

In a further embodiment, a non-transitory computer-readable medium is provided. The computer-readable medium including processor-executable code that when executed by a processing system including one or more processors, causes the processing system to perform actions. The actions include acquiring spectral computed tomography (CT) scan data. The actions also include utilizing a hybrid approach to generate spectral CT basis material maps from the spectral CT scan data, wherein the hybrid approach includes utilizing both calibration-data terms and physics-based terms, wherein the physics-based terms are configured to provide knowledge of imaging physics, and the calibration-data terms are configured to bridge a gap between the knowledge of the imaging physics and the real data.

### BRIEF DESCRIPTION OF THE DRAWINGS

These and other features, aspects, and advantages of the disclosed subject matter will become better understood when the following detailed description is read with reference to the accompanying drawings in which like characters represent like parts throughout the drawings, wherein:

FIGS. 1A and 1B are a pictorial view and a block diagram representation of a CT system, in accordance with aspects of the present disclosure;

FIG. 2 is a schematic diagram of a computing device for performing the disclosed techniques, in accordance with aspects of the present disclosure;

FIG. 3 is a schematic diagram of utilization of a hybrid model for material decomposition; in accordance with aspects of the present disclosure;

FIG. 4 is a flow chart of a method for defining a hybrid model, in accordance with aspects of the present disclosure;

FIG. 5 is a flow chart of a method for performing material decomposition (e.g., utilizing a hybrid model), in accordance with aspects of the present disclosure;

FIG. 6 depicts basis material images (e.g., polyethylene (PE) maps) reconstructed with different techniques, in accordance with aspects of the present disclosure;

FIG. 7 depicts basis material images (e.g., polyvinyl chloride (PVC) maps) reconstructed with different techniques, in accordance with aspects of the present disclosure; and

FIG. 8 is a flow chart of a method for performing material decomposition (e.g. utilizing a hybrid approach), in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where a set or type of acquired data undergoes a reconstruction process to generate an image or volume.

Energy-resolved, photon counting detectors can provide spectral information that is not available with conventional energy-integrating detectors. One type of energy-discriminating, photon counting detection technology employs silicon strips as a direct-conversion sensor material. Another common type of photon counting detector uses CZT or CdTe material.

Spectral CT is of clinical interests in numerous applications. For example, spectral CT (including the use of the disclosed techniques) may be utilized in non-invasive diagnosis in obstructive coronary artery disease, coronary atherosclerosis characterization, bone mineral density analysis, calcification quantification, and non-invasive diagnosis of urolithiasis.

The present disclosure provides embodiments for a system and a method for performing material decomposition. The disclosed embodiments enable the generation of high-quality material datasets (e.g., basis material maps) for photon counting or other forms of spectral CT (e.g., dual source CT, dual layer detector CT, fast voltage switching CT, etc.). In particular, a hybrid approach (utilizing calibration-data terms and physics-based terms) is utilized to generate or to estimate the high-quality material datasets. For example, a hybrid approach may be utilized that describes the detailed imaging processing of generating measurement data from material datasets. Most parameters of the hybrid model are determined using knowledge of imaging physics (e.g., derived from a model used in a CT simulator (e.g., called CatSim) that utilizes accurate physics-based models to generate simulated CT volumes). The hybrid model also utilizes data terms that bridge a gap between simulation and real data. Calibration scan data (e.g. from scans of slabs of different basis material combinations) are used to fit the parameters of the calibration-data term. The forward model in conjunction with an optimization-based technique or a non-iterative inverse mapping is utilized to solve for the basis material maps. In another embodiment, where material decomposition is accomplished via non-iterative evaluation of an inverse mapping, the hybrid model can similarly be used to balance physics- and calibration-data based terms to first define and then refine the inverse mapping for better estimation of the material maps.

The disclosed techniques enable producing high quality spectral CT material maps in an accurate, computationally efficient, and labor efficient (i.e., calibration effort) manner. In particular, the disclosed techniques improve the material decomposition accuracy compared to pure physics-based methods with little additional parameters. Compared to pure-calibration approaches, the disclosed techniques are simpler in terms of the calibration process (i.e., less parameters to calibrate and/or less calibration data to be acquired) and less complicated and, thus, are faster and more robust.

The disclosed embodiments include a method for performing material decomposition. The disclosed embodiments include acquiring, via a processing system including one or more processors, spectral computed tomography (CT) scan data (e.g., of a subject or a patient) (e.g., with a photon counting detector). The disclosed embodiments also include utilizing, via the processing system, hybrid models to generate spectral CT basis material maps from the spectral CT scan data, wherein hybrid models are used in conjunction with an optimization-based technique or a non-iterative inverse mapping to generate the spectral CT basis material maps, and the hybrid model include both calibration-data terms and physics-based terms.

The disclosed embodiments include a system for performing material decomposition. The system includes a memory encoding processor-executable routines. The system also includes a processing system including one or more processors and configured to access the memory and to execute the processor-executable routines, wherein the processor-executable routines, when executed by the processing system, cause the processing system to perform actions. The actions include acquiring spectral computed tomography (CT) scan data (e.g., of a subject or patient) (e.g., with a photon counting detector). The actions also include utilizing hybrid models to generate spectral CT basis material maps from the spectral CT scan data, wherein hybrid model is used in conjunction with an optimization-based technique or a non-iterative inverse mapping to generate the spectral CT basis material maps, and the hybrid model include both calibration-data terms and physics-based terms.

In certain embodiments, the optimization-based technique includes maximum likelihood, maximum a posteriori, or a physics informed neural network. In certain embodiments, the physics-based terms are configured to provide knowledge of imaging physics, and the calibration-data terms are configured to bridge a gap between the knowledge of the imaging physics and real data. In certain embodiments, the method and system includes acquiring, via the processing system, calibration scan data of different combinations of basis materials and utilizing, via the processing system, the calibration scan data to fit parameters of the calibration-data terms. In disclosed embodiments, the physics-based terms relate to a detection term (e.g., detection matrix), an incident spectrum, and a material attenuation. In disclosed embodiments, the calibration-data terms include a multiplicative data term and an additive term. In certain embodiments, the multiplicative term is pixel dependent and the additive term is pixel independent. In certain embodiments, both the multiplicative term and additive term can be pixel dependent. In disclosed embodiments, the multiplicative term includes a multiplicative pixel dependent gain term configured to account for pixel dependent gain differences during manufacturing, and the additive term includes an additive calibrated detection matrix configured to compensate for physical effects missed by the physics-based terms. In disclosed embodiments, the physics-based terms include a majority of parameters in the hybrid model. In certain embodiments, the hybrid model may be utilized as a surrogate measurement.

In disclosed embodiments, a computer-readable medium includes processor-executable code that when executed by a processing system including one or more processors, causes the processing system to perform actions. The actions include acquiring spectral computed tomography (CT) scan data (e.g., with a photon counting detector). The actions also include utilizing a hybrid approach to generate spectral CT basis material maps from the spectral CT scan data, wherein the hybrid approach includes utilizing both calibration-data terms and physics-based terms, wherein the physics-based terms are configured to provide knowledge of imaging physics, and the calibration-data terms are configured to bridge a gap between the knowledge of the imaging physics and real data. In certain embodiments, utilizing the hybrid approach includes utilizing a hybrid model in conjunction with an optimization-based technique or a non-iterative inverse mapping to generate the spectral CT basis material maps.

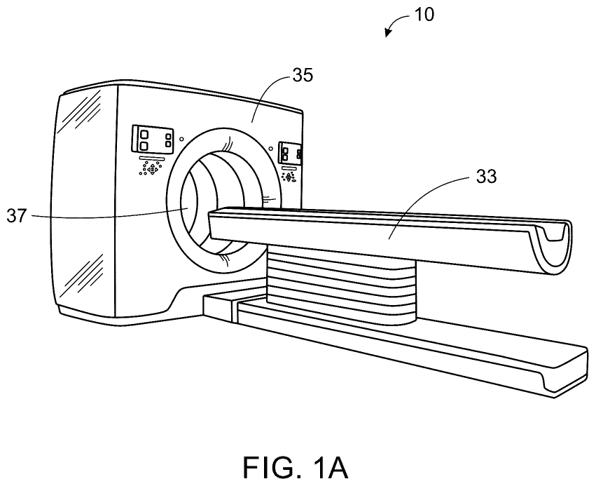

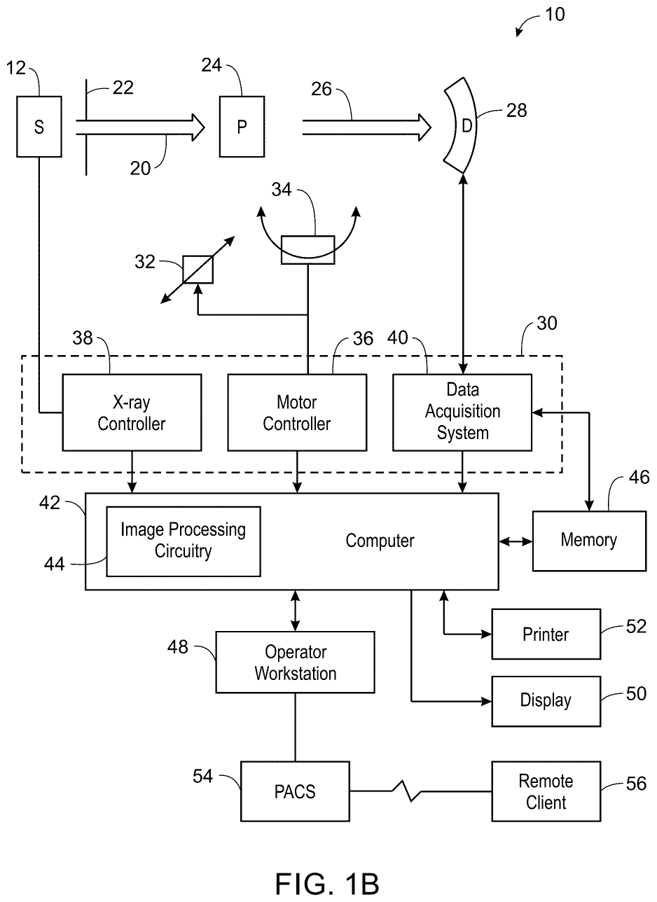

With the preceding discussion in mind, FIGS. 1A and 1B illustrate an embodiment of an imaging system 10 for acquiring and processing image data utilizing the techniques discussed herein. In the illustrated embodiment, system 10 is a computed tomography (CT) system designed to acquire X-ray projection data, to reconstruct the projection data into a tomographic image, and to process the image data for display and analysis. The CT imaging system 10 includes one or more X-ray sources 12, such as one or more X-ray tubes or solid-state emission structures which allow X-ray generation at one or more locations and/or one or more energy spectra during an imaging session.

In certain implementations, the source 12 may be positioned proximate to a collimator 22 used to define the size and shape of the one or more X-ray beams 20 that pass into a region in which a subject 24 (e.g., a patient) or object of interest is positioned. The subject 24 attenuates at least a portion of the X-rays. Resulting attenuated X-rays 26 impact a detector array 28 formed by a plurality of detector elements (e.g., pixels). As discussed herein, the detector 28 may be a photon counting detector, including an energy-discriminating photon counting detector, whose outputs convey information about the number and energy of photons that impact the detector at measured positions and over a time interval corresponding to a scan or imaging session. In certain such embodiments, the energy-discriminating, photon counting detector may be a direct-conversion type detector (i.e., not employing a scintillator intermediary), such as a detector based on silicon strips or a detector based on CZT or CdTe. In certain embodiments, the detector array 28 may be formed by a plurality of detector sub-modules or sensors (each having a plurality of detector elements such as photodiode or diodes).

When an X-ray photon interacts with a direct conversion material, a charge cloud is created. This electrical charge is measured and converted into a digital signal: i.e. a counter for the correct energy range (or energy bin) is incremented. Each detector element produces a set of counts representing the number of X-ray photons detected within a set of energy bins at the position of the detector element when the beam strikes the detector 28.

A system controller 30 commands operation of the imaging system 10 to execute examination and/or calibration protocols and to process the acquired data. With respect to the X-ray source 12, the system controller 30 furnishes power, focal spot location, control signals and so forth, for the X-ray examination sequences. The detector 28 is coupled to the system controller 30, which commands acquisition of the signals generated by the detector 28. In addition, the system controller 30, via a motor controller 36, may control operation of a linear positioning subsystem 32 (e.g., a table 33 in FIG. 1A) and/or a rotational subsystem 34 (e.g., a gantry 35 in FIG. 1A, a C-arm, etc.) used to move components of the imaging system 10 and/or the subject 24 (e.g., moving the subject 24 into and out of a bore or opening 37 of the gantry 35 in FIG. 1A). The system controller 30 may include signal processing circuitry and associated memory circuitry. In such embodiments, the memory circuitry may store programs, routines, and/or encoded algorithms executed by the system controller 30 to operate the imaging system 10, including the X-ray source 12, and to process the data acquired by the detector 28 in accordance with the steps and processes discussed herein. In one embodiment, the system controller 30 may be implemented as all or part of a processor-based system such as a general purpose or application-specific computer system.

The source 12 may be controlled by an X-ray controller 38 contained within the system controller 30. The X-ray controller 38 may be configured to provide power and timing signals to the source 12. In addition, in some embodiments the X-ray controller 38 may be configured to selectively activate the source 12 such that tubes or emitters at different locations within the system 10 may be operated in synchrony with one another or independent of one another.

The system controller 30 may include a data acquisition system (DAS) 40. The DAS 40 receives data collected by readout electronics (e.g., ASICs) of the detector 28, such as sampled analog signals from the detector 28. The DAS 40 may then convert the data to digital signals for subsequent processing by a processor-based system, such as a computer 42. In other embodiments, the detector 28 may convert the sampled analog signals to digital signals prior to transmission to the data acquisition system 40. The computer may include processing circuitry 44 (e.g., image processing circuitry). The computer 42 may include or communicate with one or more non-transitory memory devices 46 that can store data processed by the computer 42, data to be processed by the computer 42, or instructions to be executed by a processor (e.g., processing circuitry 44) of the computer 42. For example, the processing circuitry 44 of the computer 42 may execute one or more sets of instructions stored on the memory 46, which may be a memory of the computer 42, a memory of the processor, firmware, or a similar instantiation.

The computer 42 may also be adapted to control features enabled by the system controller 30 (i.e., scanning operations and data acquisition), such as in response to commands and scanning parameters provided by an operator via an operator workstation 48. The system 10 may also include a display 50 coupled to the operator workstation 48 that allows the operator to view relevant system data, imaging parameters, raw imaging data, reconstructed data, and so forth. Additionally, the system 10 may include a printer 52 coupled to the operator workstation 48 and configured to print any desired measurement results. The display 50 and the printer 52 may also be connected to the computer 42 directly or via the operator workstation 48. Further, the operator workstation 48 may include or be coupled to a picture archiving and communications system (PACS) 54. PACS 54 may be coupled to a remote system 56, radiology department information system (RIS), hospital information system (HIS) or to an internal or external network, so that others at different locations can gain access to the image data.

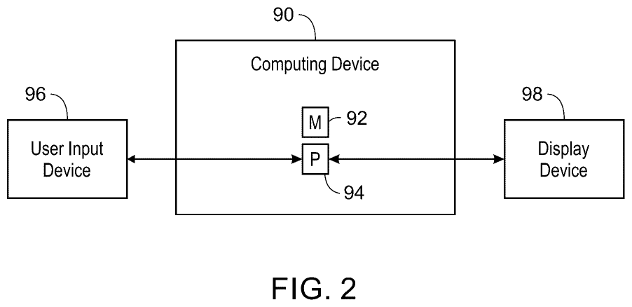

FIG. 2 is a schematic diagram of a computing device 90 for performing the disclosed techniques herein. The computing device 90 may be computer 42 of the computed tomography (CT) imaging system 10 in FIG. 1 or a remote computing device. In certain embodiments, the computing device 90 may be a remote cloud-based processing system.

The computing device 90 includes a memory 92 and a processing system 94. In some embodiments, the processing system 94 may include one or more general purpose processors, one or more application specific integrated circuits, one or more field programmable gate arrays, or the like. Additionally, the memory 92 may be any tangible, non-transitory, computer readable medium that is capable of storing instructions executable by the processing system 94 and/or data that may be processed by the processor 94. In other words, the memory 92 may include volatile memory, such as random-access memory, or non-volatile memory, such as hard disk drives, read only memory, optical disks, flash memory, and the like. The memory 92 may store imaging data, hybrid models for spectral CT material decomposition, and other data.

The computing device 90 is communicatively coupled with a user input device 96 and a display device 98. The user input device 96 may include one or more of a touchscreen, a keyboard, a mouse, a trackpad, a motion sensing camera, or other device configured to enable a user to interact with the computing device 90. The display device 98 may include one or more display devices utilizing virtually any type of technology. In some embodiments, the display device 98 may include a computer monitor, and may display imaging data (e.g., basis material composition images). The display device 98 may be combined with the processing system 94, the non-transitory memory 92, and/or the user input device 96 in a shared enclosure, or may be peripheral display devices and may comprise a monitor, touchscreen, projector, or other display device known in the art, which may enable a user to view data and/or interact with various data stored in the non-transitory memory 92.

As described in greater detail below, the processing system 94 is configured to performing material decomposition. In particular, the processing system 94 is configured to acquire spectral CT scan data (e.g., bin measurement data) (e.g., with a photon counting detector). The processing system 94 is configured to utilize a hybrid model in conjunction with an optimization-based technique or a non-iterative inverse mapping to generate spectral CT basis material maps from the spectral CT scan data, wherein the hybrid model includes both calibration-data terms and physics-based terms.

In certain embodiments, the optimization-based technique includes maximum likelihood, maximum a posteriori, or a physics informed neural network. In certain embodiments, the physics-based terms are configured to provide knowledge of imaging physics, and the calibration-data terms are configured to bridge a gap between the knowledge of the imaging physics and real data. In certain embodiments, the processing system 94 is configured to acquire calibration scan data of different combinations of basis materials and to utilize the calibration scan data to fit parameters of the calibration-data terms. In certain embodiments, the physics-based terms relate to a detection term (e.g., detection matrix), an incident spectrum, and a material attenuation. In certain embodiments, the calibration-data terms include a multiplicative data term and an additive term. In certain embodiments, the multiplicative term is pixel dependent and the additive term is pixel independent. In certain embodiments, both the multiplicative term and additive term can be pixel dependent. In certain embodiments, the multiplicative term includes a multiplicative pixel dependent gain term configured to account for pixel dependent gain differences during manufacturing, and the additive term includes an additive calibrated detection matrix configured to compensate for physical effects missed by the physics-based terms. In certain embodiments, the physics-based terms include a majority of parameters in the hybrid model. In certain embodiments, the hybrid model may be utilized as a surrogate measurement.

The processing system 94 is configured to acquire spectral CT scan data (e.g., with a photon counting detector). The processing system 94 is configured to utilize a hybrid approach to generate spectral CT basis material maps from the spectral CT scan data, wherein the hybrid approach includes utilizing both calibration-data terms and physics-based terms, wherein the physics-based terms are configured to provide knowledge of imaging physics, and the calibration-data terms are configured to bridge a gap between the knowledge of the imaging physics and real data. In certain embodiments, the processing system 94 is configured when utilizing the hybrid approach to utilize a hybrid model in conjunction with an optimization-based technique or non-iterative inverse mapping to generate the spectral CT basis material maps.

The disclosed techniques solve for material maps from measurement data (e.g., multiple bin measurement data). The workflow is that of solving an inverse problem, which requires an accurate definition of a model. The hybrid model contains both imaging physics (i.e., physic-based terms) and careful calibration (i.e., data terms). Most of (i.e., the majority) of the parameters of the hybrid model are physics-based terms. The physics-based terms of the hybrid model is described by the following equation:

$${\hat{y}}_{i , m} = {\sum }_{j} {W}_{m , j} {\sum }_{k} {R}_{j , k} {a}_{k} {e}^{- {\sum }_{n} {M}_{k , n} {v}_{i , n}} {S}_{i , k}$$

(1) where y_{i,m} is the measurement data for the i-th detector pixel and the m-th energy bin, W_{m,j} is an element of the detector energy weighting matrix, R_{j,k} is an element of the detector response matrix, aₖ is the detector absorption for the kth incoming energy bin, e^{-ε}^{ₙ}^{M}^{_{k,n}}^{v}^{_{i,n}} is the object attenuation for the kth incoming energy bin, S_{i,k} is the incident spectrum for the ith pixel and the kth incoming energy, j is the response energy, M_{k,n} is an element of a matrix of energy-dependent material attenuation coefficients, and v_{i,n} is the n-th basis material path length in the vector vᵢ (which is the target of the algorithm). This equation can be simplified to the following:

$${\hat{y}}_{i} = D ( {S}_{i} ∘ {e}^{- {Mv}_{i}} ) \qquad ( 2 )$$

where the physics-based term D represents the detection matrix (it combines W, R, and a from the previous equation into a single matrix), the physics-based term Sᵢ represents incident spectrum for the pixel as mentioned above, and the physics-based term M represents a matrix of energy-dependent material attenuation coefficients as mentioned above. In the above equation, ∘ represents element-wise multiplication. The physics-based terms are determined or defined using knowledge of imaging physics (e.g., derived from a model used in a CT simulator (e.g., called CatSim) that utilizes accurate physics-based models to generate simulated CT volumes). Note that while this equation incorporates lots of physics effects already, it has limitations (e.g., crosstalk and pileup effects are not modeled). Also, manufacturing limitations may result in different properties for different pixels (such as the gain per pixel), which is why only using the physics term in the forward model typically result in inaccurate material decomposition results. Thus, the calibration-data terms are added to compensate for that.

The calibration-data terms are separated into a multiplicative term and an additive term. Adding calibration-data terms, the hybrid model is defined by the following equation:

$${\hat{y}}_{i} = {V}_{i} \cdot [ D ( Si ∘ {e}^{- {Mv}_{i}} ) + C ( Si ∘ {e}^{- {Mv}_{i}} ) ] \qquad ( 3 )$$

where calibration-data term C represents the additive calibrated detection matrix to compensate for the physical effects missed by the physics terms (e.g., crosstalk and pile up). This term is additive (and not pixel-dependent) because effects like crosstalk are mostly additive. In certain embodiments, C is pixel-dependent (e.g., Cᵢ) The other data term Vᵢ is the multiplicative pixel dependent gain term (scalar per pixel). This term is also multiplicative. It accounts for pixel dependent gain differences during manufacturing. In certain embodiments, Vᵢ can be replaced by a polynomial function.

The defined model terms in Equation 3 bridge the gap between our knowledge of the imaging physics and the measurement data. The terms involving C need to be calibrated. To calibrate C, scans of different combinations of basis materials (e.g., slabs of polyethylene (PE) and polyvinyl chloride (PVC)) are conducted and calibration data utilized to fit parameters. Then an optimization problem for finding C can be solved by minimizing the difference between ŷᵢ in Equation 3 and the calibration scan. Regularization techniques (e.g., singular value threshold and ridge regression) can be used to stabilize the calibrated C matrix, which should be non-singular and have a low L0 norm. In certain embodiments, other calibration methods for C (e.g., with different cost/solver) can be utilized. Then, as for Vᵢ, it can be calibrated by scanning PE phantoms with different thicknesses. Vᵢ can be found by dividing real measured data by the estimated measure data. The calibration step is only required once in a while (e.g., when installing the system and when doing routine calibrations). The calibration does not need to be repeated for every scan.

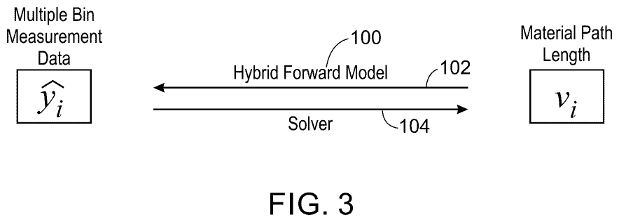

FIG. 3 is a schematic diagram of utilization of a hybrid model 100 (e.g., as defined in Equation 3) for material decomposition. The hybrid model 100 defines the forward operation of going from material path length vᵢ (i.e., projection domain of basis material maps) to multiple bin measure data ŷᵢ. Once the hybrid model 100 is defined (from vᵢ to ŷᵢ as indicated by arrow 102), the hybrid model 100 can be utilized with an optimization-based technique or a non-iterative inverse mapping to solve the inverse problem (from ŷᵢ to vᵢ as indicated by arrow 104) to generate material images using the hybrid model 100 and the measured data. The hybrid model 100 allows for easy first and second order derivatives calculation (e.g., gradient and Hessian), which facilitates the usage of a number of optimization-based techniques. In certain embodiments, the optimization-based technique utilized may be a maximum likelihood approach. For example, under a Poisson noise model, a negative log-likelihood, L, is defined by the following equation:

$$L = {\sum }_{i} {y}_{i} ln {\hat{y}}_{i} - {\hat{y}}_{i} . \qquad ( 4 )$$

The maximum likelihood approach can be utilized to solve for vᵢ using measurement data yᵢ and the hybrid model 100. In certain embodiments, the optimization-based technique utilized may be a maximum a posteriori approach, which adds another prior term to L, and then solves for vᵢ using measurement data yᵢ and the hybrid model 100. In certain embodiments, the optimization-based technique may be a deep learning model with an explicitly defined model (e.g., a physics informed neural network (PINN)). With the PINN approach, which solves for vᵢ by learning the optimal mapping between yᵢ and vᵢ using multiple pairs of yᵢ and vᵢ (training data), the hybrid d model 100 provides the physics-based loss function in the training process.

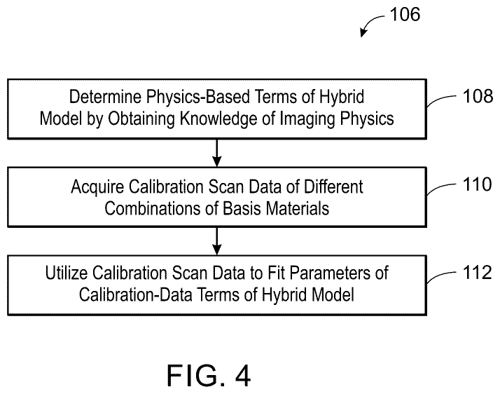

FIG. 4 is a flow chart of a method 106 for defining a hybrid model. Some or all of the steps of the method 106 may be performed by the computing device 90 in FIG. 2. Although the method 106 is described herein in the context of spectral CT with photon counting detectors, it may be utilized with other forms of spectral CT (e.g. dual energy, dual detection layers, etc.).

The method 106 includes determining physics-based terms of the hybrid model by obtaining knowledge of imaging physics from a model utilized in a CT simulator that utilizes accurate physics-based models to generate simulated CT volumes (block 108). The method 106 also includes acquiring calibration scan data of different combinations of basis materials (block 110). The method 106 further includes utilizing the calibration scan data to fit parameters of the calibration-data terms of the hybrid model (block 112).

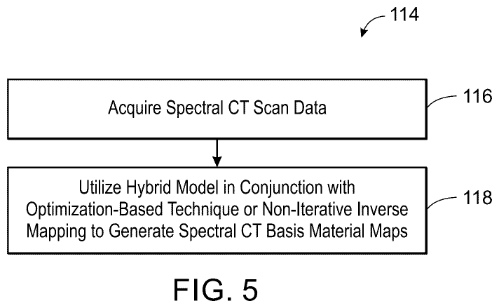

FIG. 5 is a flow chart of a method 114 for performing material decomposition (e.g., utilizing a hybrid model). Some or all of the steps of the method 114 may be performed by the computing device 90 in FIG. 2. Although the method 114 is described herein in the context of spectral CT with photon counting detectors, it may be utilized with other forms of spectral CT (e.g. dual energy, dual detection layers, etc.).

The method 114 includes acquiring spectral computed tomography (CT) scan data (e.g., of a subject such as a patient) (e.g., with a photon counting detector) (block 116). The method 114 also includes utilizing a hybrid model in conjunction with an optimization-based technique or a non-iterative inverse mapping to generate spectral CT basis material maps from the spectral CT scan data (block 118). The hybrid model includes both calibration-data terms and physics-based terms as described above.

In certain embodiments, the optimization-based technique includes maximum likelihood, maximum a posteriori, or a physics informed neural network. In certain embodiments, the physics-based terms are configured to provide knowledge of imaging physics, and the calibration-data terms are configured to bridge a gap between the knowledge of the imaging physics and real data. In certain embodiments, the physics-based terms relate to a detection term (e.g., detection matrix), an incident spectrum, and a material attenuation. In certain embodiments, the data terms include a multiplicative data term and an additive term. In certain embodiments, the multiplicative term is pixel dependent and the additive term is pixel independent. In certain embodiments, both the multiplicative term and additive term can be pixel dependent. In certain embodiments, the multiplicative term includes a multiplicative pixel dependent gain term configured to account for pixel dependent gain differences during manufacturing, and the additive term includes an additive calibrated detection matrix configured to compensate for physical effects missed by the physics-based terms. In certain embodiments, the physics-based terms include a majority of parameters in the hybrid model. In certain embodiments, the hybrid model may be utilized as a surrogate measurement.

As noted, the model is a hybrid model that relies on both imaging physics (physics-based terms) and calibration data (data terms). Most previous techniques rely on either imaging physics or calibration data alone. When building the hybrid model more emphasis is placed on the physics-based terms (which make up the majority of parameters of the hybrid model) and data terms are only resorted to when necessary. The data terms are formed after incident spectrum distortion (which is one of the biggest sources for spatial dependence). Therefore, we can reduce the spatial dependence and calibration difficulty of the data term.

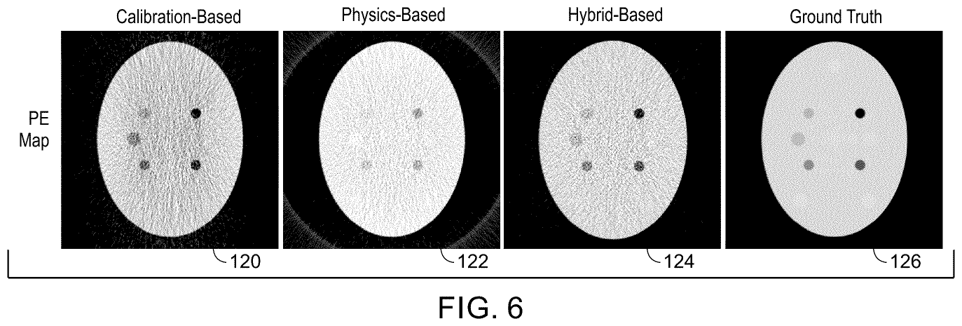

FIG. 6 depicts basis material images (e.g., polyethylene (PE) maps) reconstructed with different techniques. The basis material images derived from spectral CT data (acquired utilizing a photon-counting detector) of a phantom (e.g., Gammex™ phantom) having PE and PVC basis materials (e.g., inserts) utilizing different techniques. Image 120 is a PE map obtained utilizing a calibration-based only approach. Image 122 is a PE map obtained utilizing a physics-based only approach. Image 124 is a PE map obtained utilizing a hybrid-based approach (e.g., as disclosed in the method 114 in FIG. 5). Image 126 is a ground truth PE map.

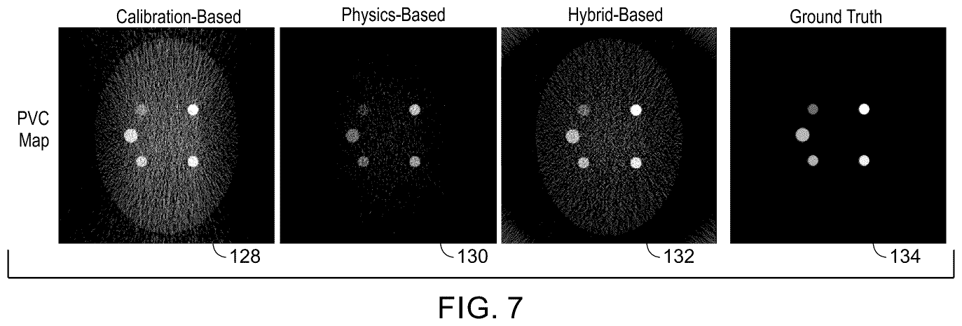

FIG. 7 depicts basis material images (e.g., polyvinyl chloride (PVC) maps) reconstructed with different techniques. The basis material images derived from spectral CT data (acquired utilizing a photon-counting detector) of a phantom (e.g., Gammex™ phantom) having PE and PVC basis materials (e.g., inserts) utilizing different techniques. Image 128 is a PVC map obtained utilizing a calibration-based only approach. Image 130 is a PVC map obtained utilizing a physics-based only approach. Image 132 is a PVC map utilized in a hybrid-based approach (e.g., as disclosed in the method 114 in FIG. 5). Image 134 is a ground truth PE map.

As depicted in FIGS. 6 and 7, the hybrid-based approach provides better accuracy and better noise property than both the pure calibration-based approach and the pure physics-based approach. The hybrid-based approach improves the material decomposition accuracy compared to the pure physics-based approach with little additional parameters. Compared to the pure calibration-based approach, the hybrid-based approach is simpler in terms of the calibration process (i.e., less parameters to calibrate) and is less complicated. Thus, the hybrid-based approach is faster and more robust than the pure calibration-based approach.

An alternative approach based on non-iterative evaluation of an inverse mapping that converts measured data to material pathlengths may be utilized to estimate material maps. For a given detector pixel, let:

$${p}_{kn}^{phy}$$

be the p-value of n^{th} energy bin, n=1 . . . N, of k^{th} physics-based simulated calibration dataset (e.g., k^{th} simulated slab), k=1 . . . K, and

$${p}_{kl}^{phy}$$

be the attenuation-value at a monochromatic energy for the l^{th} material path-length, l=1 . . . L, of k^{th} physics-based simulated calibration dataset (e.g., k^{th} simulated slab). A matrix, A^{phy}, is constructed where matrix

$${A}^{phy} = ( {a}_{kj}^{phy} )$$

of multivariate monomial terms

$${a}_{kj}^{phy} = {( {p}_{k 1}^{phy} )}^{{j}_{1}} \times … \times {( {p}_{kN}^{phy} )}^{{j}_{N}}$$

with jₙ=0 . . . J−1 indicate the degree of each univariate monomial term. Then, a system of equations can be formed:

$$[ \begin{matrix}{m}_{11}^{phy} \\ ⋮ \\ {m}_{KL}^{phy}\end{matrix} ] = [ \begin{matrix}{a}_{11}^{phy} & … & {a}_{1 M}^{phy} \\ ⋮ & ⋱ & ⋮ \\ {a}_{k 1}^{phy} & … & {a}_{KM}^{phy}\end{matrix} ] [ \begin{matrix}{c}_{1} \\ ⋮ \\ {c}_{M}\end{matrix} ] \qquad ( 5 )$$

with M polynomial terms, where cⱼ is polynomial coefficients corresponding to j^{th} multivariate monomial

$${a}_{kj}^{cal} .$$

Equation 5 can be written as:

$${m}^{phy} = {A}^{phy} \times c . \qquad ( 6 )$$

Solving for c using total-least squares approach,

$$c = {( {A}^{{phy}^{′}} {A}^{phy} )}^{- 1} {A}^{{phy}^{′}} {m}^{phy} , \qquad ( 7 )$$

the following can be computed:

$${m}^{est} = {A}^{data} \times c , \qquad ( 8 )$$

to estimate m^{est} (monochromatic attenuation or material path lengths) from measured scan data arranged in the format of A^{data} similar to that of A^{phy}.

If certain calibration measurements are acquired such that:

$${p}_{kn}^{cal}$$

is the p-value of n^{th} energy bin, n=1 . . . N, of k^{th} acquired calibration dataset (e.g., k^{th} acquired slab), k=1 . . . K_{cal}, and

$${m}_{kl}^{cal} = {m}_{kl}^{phy}$$

be the attenuation-value at a monochromatic energy for the l^{th} material path-length, l=1 . . . L, of k^{th} acquired calibration dataset (e.g., k^{th} acquired slab). These acquired calibration datasets may form a subset of the physics-based simulated calibration space (e.g., subset of simulated slabs), i.e., K_{cal}<K, where K is the number of physics-based simulated calibration datasets, so that the effort spent on preparing and acquiring calibration datasets is much less than compared to pure-calibration based approaches.

The known ground truth monochromatic attenuation or material path length does not change as the acquired calibration data is a subset of physics-based simulated calibration data. It can be assumed that:

$${p}_{cn}^{cal} = {p}_{cn}^{phy} + {δ}_{cn}^{cal} , \qquad ( 9 )$$

i.e., the acquired calibration p-value is a perturbation of the physics-based one, where the magnitude of

$$\vert {δ}_{cn}^{cal} \vert ≪ 1.$$

Correspondingly, the following perturbation can be considered:

$$B = {A}^{phy} + {Δ}^{cal} , \qquad ( 10 )$$

and a linear system similar to Equation 6 setup:

$${m}^{phy} = B \times d . \qquad ( 11 )$$

Solving for d, the following can be written as:

$$d = {( {B}^{′} B )}^{- 1} {B}^{′} {m}^{phy} . \qquad ( 12 )$$

Considering the following expansion (ignoring subscripts/superscripts, and defining F=A′Δ+Δ′A+Δ′A):

$${B}^{′} B = {A}^{′} A + F . \qquad ( 13 )$$

Then assuming (I>(A′A)⁻¹F) which may be the case if

$$\vert {δ}_{cn}^{cal} \vert ≪ 1 ,$$

(B′B)⁻¹ can be approximated as:

$${( {B}^{′} B )}^{- 1} = {( {A}^{′} A + F )}^{- 1} = {( I + {( {A}^{′} A )}^{- 1} F )}^{- 1} {( {A}^{′} A )}^{- 1} \approx ( I - {( {A}^{′} A )}^{- 1} F ) {( {A}^{′} A )}^{- 1} = {( {A}^{′} A )}^{- 1} - G , \qquad ( 14 )$$

$$where :$$

$$G = {( {A}^{′} A )}^{- 1} {F ( {A}^{′} A )}^{- 1} . \qquad ( 15 )$$

Then, Equation 12 can be written as:

$$d \approx {( {( {A}^{′} A )}^{- 1} )}^{- 1} - G ) {B}^{′} {m}^{p h y} = ( {( {A}^{′} A )}^{- 1} - G ) ( {A}^{′} + {Δ}^{′} ) {m}^{phy} \approx {( {A}^{′} A )}^{- 1} {A}^{′} {m}^{phy} - G ( {A}^{′} + {Δ}^{′} ) {m}^{phy} = c - G ( {A}^{′} + {Δ}^{′} ) {m}^{phy} , \qquad ( 16 )$$

That is, d is a correction to c from Equation 7, so that we can start from c in Equation 7 and perturb it based on acquired calibration dataset. Once d is available, then the following can be computed:

$${m}^{est} = {A}^{data} \times d , \qquad ( 17 )$$

to obtain m^{est} (monochromatic attenuation or material path lengths) for measured scan data arranged in the format of A^{data} similar to that in Equation 8.

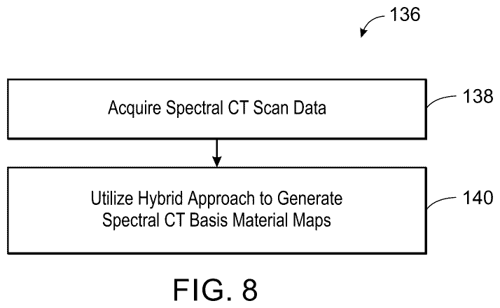

FIG. 8 is a flow chart of a method 136 for performing material decomposition (e.g., utilizing a hybrid approach). Some or all of the steps of the method 136 may be performed by the computing device 90 in FIG. 2. Although the method 136 is described herein in the context of spectral CT with photon counting detectors, it may be utilized with other forms of spectral CT (e.g. dual energy, dual detection layers, etc.).

The method 136 includes acquiring spectral computed tomography (CT) scan data (e.g., of a subject such as a patient) (e.g., with a photon counting detector) (block 138). The method also includes utilizing a hybrid approach to generate spectral CT basis material maps from the spectral CT scan data (block 140), wherein the hybrid approach comprises utilizing both calibration-data terms and physics-based terms, wherein the physics-based terms are configured to provide knowledge of imaging physics, and the calibration-data terms are configured to bridge a gap between the knowledge of the imaging physics and real data. The hybrid approach may be as described in equations 9 through 17 above. In certain embodiments, utilizing the hybrid approach comprises utilizing a hybrid model in conjunction with an optimization-based technique to generate the spectral CT basis material maps. In other embodiments, utilizing the hybrid approach comprises evaluating a non-iterative inverse mapping that is constructed from physics- and calibration-based models (e.g., such as described by Equations 5 to 17 above).

In certain embodiments, the optimization-based technique includes maximum likelihood, maximum a posteriori, or a physics informed neural network. In disclosed embodiments, the physics-based terms relate to a detection term (e.g., detection matrix), an incident spectrum and a material attenuation. In disclosed embodiments, the data terms include a multiplicative data term and an additive term. In disclosed embodiments, the multiplicative term is pixel dependent and the additive term is pixel independent. In certain embodiments, both the multiplicative term and additive term can be pixel dependent. In disclosed embodiments, the multiplicative term includes a multiplicative pixel dependent gain term configured to account for pixel dependent gain differences during manufacturing, and the additive term includes an additive calibrated detection matrix configured to compensate for physical effects missed by the physics-based terms. In disclosed embodiments, the physics-based terms include a majority of parameters in the hybrid model. In certain embodiments, the hybrid model may be utilized as a surrogate measurement.

Technical effects of the disclosed embodiments include enabling producing high quality spectral CT material maps in an accurate, computationally efficient, and labor efficient (i.e., calibration effort) manner. In particular, the disclosed techniques improve the material decomposition accuracy compared to pure physics-based methods with little additional parameters. Compared to pure-calibration approaches, the disclosed techniques are simpler in terms of the calibration process (i.e., less parameters to calibrate and/or less calibration data to be acquired) and less complicated and, thus, are faster and more robust.

The disclosure also provides support for a computer-implemented method for performing material decomposition, comprising: acquiring, via a processing system comprising one or more processors, spectral computed tomography (CT) scan data; and utilizing, via the processing system, a hybrid model in conjunction with an optimization-based technique or a non-iterative inverse mapping to generate spectral CT basis material maps from the spectral CT scan data, wherein the hybrid model comprises both calibration-data terms and physics-based terms. In a first example of the computer-implemented method, the optimization-based technique comprises maximum likelihood, maximum a posteriori, or a physics informed neural network. In a second example of the computer-implemented method, optionally including the first example, the physics-based terms are configured to provide knowledge of imaging physics, and the calibration-data terms are configured to bridge a gap between the knowledge of the imaging physics and real data. In a third example of the computer-implemented method, optionally including one or both of the first and second examples, the computer-implemented method further comprises: acquiring, via the processing system, calibration scan data of different combinations of basis materials; and utilizing, via the processing system, the calibration scan data to fit parameters of the data terms. In a fourth example of the computer-implemented method, optionally including one or more or each of the first through third examples, the physics-based terms relate to a detection term, an incident spectrum, and a material attenuation. In a fifth example of the computer-implemented method, optionally including one or more or each of the first through fourth examples, the data terms comprise a multiplicative data term and an additive term. In a sixth example of the computer-implemented method, optionally including one or more or each of the first through fifth examples, the multiplicative term is pixel dependent and the additive term is pixel independent or both the multiplicative term and the additive term are pixel dependent. In a seventh example of the computer-implemented method, optionally including one or more or each of the first through sixth examples, the multiplicative term comprises a multiplicative pixel dependent gain term configured to account for pixel dependent gain differences during manufacturing, and the additive term comprises an additive calibrated detection matrix configured to compensate for physical effects missed by the physics-based terms. In an eighth example of the computer-implemented method, optionally including one or more or each of the first through seventh examples, the physics-based terms comprise a majority of parameters in the hybrid model.

The disclosure also provides support for a system for performing material decomposition, comprising: a memory encoding processor-executable routines; and a processing system comprising one or more processors and configured to access the memory and to execute the processor-executable routines, wherein the processor-executable routines, when executed by the processing system, cause the processing system to: acquire spectral computed tomography (CT) scan data; and utilize a hybrid model in conjunction with an optimization-based technique or a non-iterative inverse mapping to generate spectral CT basis material maps from the spectral CT scan data, wherein the hybrid model comprises both calibration-data terms and physics-based terms. In a first example of the system, the optimization-based technique comprises maximum likelihood, maximum a posteriori, or a physics informed neural network. In a second example of the system, optionally including the first example, the physics-based terms are configured to provide knowledge of imaging physics, and the calibration-data terms are configured to bridge a gap between the knowledge of the imaging physics and real data. In a third example of the system, optionally including one or both of the first and second examples, the computer-implemented method further comprises: acquiring, via the processing system, calibration scan data of different combinations of basis materials; and utilizing, via the processing system, the calibration scan data to fit parameters of the data terms. In a fourth example of the system, optionally including one or more or each of the first through third examples, the physics-based terms relate to a detection term, an incident spectrum and a material attenuation. In a fifth example of the system, optionally including one or more or each of the first through fourth examples, the data terms comprise a multiplicative data term and an additive term. In a sixth example of the system, optionally including one or more or each of the first through fifth examples, the multiplicative term is pixel dependent and the additive term is pixel independent or both the multiplicative term and the additive term are pixel dependent. In a seventh example of the system, optionally including one or more or each of the first through sixth examples, the multiplicative term comprises a multiplicative pixel dependent gain term configured to account for pixel dependent gain differences during manufacturing, and the additive term comprises an additive calibrated detection matrix configured to compensate for physical effects missed by the physics-based terms. In an eighth example of the system, optionally including one or more or each of the first through seventh examples, the physics-based terms comprise a majority of parameters in the hybrid model.

The disclosure also provides support for a non-transitory computer-readable medium, the computer-readable medium comprising processor-executable code that when executed by a processing system comprising one or more processors, causes the processing system to: acquire spectral computed tomography (CT) scan data; and utilize a hybrid approach to generate spectral CT basis material maps from the spectral CT scan data, wherein the hybrid approach comprises utilizing both calibration-data terms and physics-based terms, wherein the physics-based terms are configured to provide knowledge of imaging physics, and the calibration-data terms are configured to bridge a gap between the knowledge of the imaging physics and real data. In a first example of the non-transitory computer-readable medium, utilizing the hybrid approach comprises utilizing a hybrid model in conjunction with an optimization-based technique or a non-iterative inverse mapping to generate the spectral CT basis material maps.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for performing material decomposition, comprising:
acquiring, via a processing system comprising one or more processors, spectral computed tomography (CT) scan data; and
utilizing, via the processing system, a hybrid model in conjunction with an optimization-based technique or a non-iterative inverse mapping to generate spectral CT basis material maps from the spectral CT scan data, the hybrid model comprises both calibration-data terms and physics-based terms.

2. The computer-implemented method of claim 1, wherein the optimization-based technique comprises maximum likelihood, maximum a posteriori, or a physics informed neural network.

3. The computer-implemented method of claim 1, wherein the physics-based terms are configured to provide knowledge of imaging physics, and the calibration-data terms are configured to bridge a gap between the knowledge of the imaging physics and real data.

4. The computer-implemented method of claim 3, further comprising:
acquiring, via the processing system, calibration scan data of different combinations of basis materials; and
utilizing, via the processing system, the calibration scan data to fit parameters of the calibration-data terms.

5. The computer-implemented method of claim 3, wherein the physics-based terms relate to a detection term, an incident spectrum, and a material attenuation.

6. The computer-implemented method of claim 3, wherein the data terms comprise a multiplicative data term and an additive term.

7. The computer-implemented method of claim 6, wherein the multiplicative term is pixel dependent and the additive term is pixel independent or both the multiplicative term and the additive term are pixel dependent.

8. The computer-implemented method of claim 7, wherein the multiplicative term comprises a multiplicative pixel dependent gain term configured to account for pixel dependent gain differences during manufacturing, and the additive term comprises an additive calibrated detection matrix configured to compensate for physical effects missed by the physics-based terms.

9. The computer-implemented method of claim 3, wherein the physics-based terms comprise a majority of parameters in the hybrid model.

10. A system for performing material decomposition, comprising:
a memory encoding processor-executable routines; and
a processing system comprising one or more processors and configured to access the memory and to execute the processor-executable routines, wherein the processor-executable routines, when executed by the processing system, cause the processing system to:
acquire spectral computed tomography (CT) scan data; and
utilize a hybrid model in conjunction with an optimization-based technique or a non-iterative inverse mapping to generate spectral CT basis material maps from the spectral CT scan data, wherein the hybrid model comprises both calibration-data terms and physics-based terms.

11. The system of claim 10, wherein the optimization-based technique comprises maximum likelihood, maximum a posteriori, or a physics informed neural network.

12. The system of claim 10, wherein the physics-based terms are configured to provide knowledge of imaging physics, and the calibration-data terms are configured to bridge a gap between the knowledge of the imaging physics and real data.

13. The system of claim 12, wherein the processor-executable routines, when executed by the processing system, further cause the processing system to:
acquire calibration scan data of different combinations of basis materials; and
utilize the calibration scan data to fit parameters of the data terms.

14. The system of claim 12, wherein the physics-based terms relate to a detection term, an incident spectrum, and a material attenuation.

15. The system of claim 12, wherein the data terms comprise a multiplicative data term and an additive term.

16. The system of claim 15, wherein the multiplicative term is pixel dependent and the additive term is pixel independent or both the multiplicative term and the additive term are pixel dependent.

17. The system of claim 16, wherein the multiplicative term comprises a multiplicative pixel dependent gain term configured to account for pixel dependent gain differences during manufacturing, and the additive term comprises an additive calibrated detection matrix configured to compensate for physical effects missed by the physics-based terms.

18. The system of claim 12, wherein the physics-based terms comprise a majority of parameters in the hybrid model.

19. A non-transitory computer-readable medium, the computer-readable medium comprising processor-executable code that when executed by a processing system comprising one or more processors, causes the processing system to:
acquire spectral computed tomography (CT) scan data; and
utilize a hybrid approach to generate spectral CT basis material maps from the spectral CT scan data, wherein the hybrid approach comprises utilizing both calibration-data terms and physics-based terms, wherein the physics-based terms are configured to provide knowledge of imaging physics, and the calibration-data terms are configured to bridge a gap between the knowledge of the imaging physics and real data.

20. The non-transitory computer-readable medium of claim 19, wherein utilizing the hybrid approach comprises utilizing a hybrid model in conjunction with an optimization-based technique or a non-iterative inverse mapping to generate the spectral CT basis material maps.
